(19) United States
(12) Patent Application Publication
(10) Pub. No.: US 2015/0047734 A1
(43) Pub. Date: Feb. 19, 2015

(54) PIPE AND METHOD FOR MANUFACTURING PIPE

(71) Applicant: HITACHI ZOSEN CORPORATION, Osaka (JP)

(72) Inventors: Shunsuke Kanagawa, Osaka (JP); Donghui Ma, Osaka (JP); Jun Okada, Osaka (JP); Satoshi Ashida, Osaka (JP); Kazuya Etou, Osaka (JP); Keita Yanagihara, Osaka (JP)

(21) Appl. No.: 14/387,466

(22) PCT Filed: Mar. 25, 2013
(86) PCT No.: PCT/JP2013/058604

§ 371 Date: Sep. 23, 2014

(30) Foreign Application Priority Data
Mar. 29, 2012 (JP) 2012-075699

(51) Int. Cl. F16L 9/12; F16L 15/00

(52) U.S. Cl. CPC F16L 9/12; F16L 15/00
USPC 138/153; 29/428

(57) ABSTRACT

A pipe includes: a tubular pipe main body made from fiber reinforced plastic; and a substantially tubular connection portion centered on a central axis of the pipe main body, which receives an end portion of the pipe main body, thereby being fixed to the end portion, the connection portion having an external tapered male screw portion. The male screw portion engages a tapered female screw portion on an internal surface of a substantially tubular coupling of another pipe main body. The male screw portion includes, near a screw thread surface, a corresponding metallic mesh layer as a reinforcement layer, other regions of the tapered male screw portion being made from resin, to suppress breakage of the male screw portion.

### TECHNICAL FIELD

The present invention relates to a pipe and a method for manufacturing a pipe.

### BACKGROUND ART

Conventionally, when one pipe is connected to another pipe, a joint structure has been used in which a tapered male screw portion that is formed on an external surface of the pipes and a tapered female screw portion that is formed on an internal surface of a substantially tubular-shaped coupling are screwed together (see JP S37-9634B, for example). A pipe that is made from fiber reinforced plastic has also been used conventionally. In the case of such a pipe, an end portion of a pipe main body that is made from fiber reinforced plastic is inserted into a substantially tubular-shaped connection portion having a tapered male screw portion on its external surface so that the connection portion is fixed to the end portion.

Meanwhile, as described above, when pipes made from fiber reinforced plastic are used for, for example, pumping crude oil from an oil well, many pipes are connected to one another via couplings in a vertical direction, so that a very large tensile load is exerted on each pipe. At this time, a large stress may locally occur at screw threads of a tapered male screw portion that is provided on an end of the pipe, causing the tapered male screw portion to be broken.

### SUMMARY OF INVENTION

The present invention is directed to a pipe, and it is an object thereof to suppress breakage of a male screw portion.

A pipe according to the present invention includes: a pipe main body that has a tubular shape and is made from fiber reinforced plastic; and a connection portion that is a member having a substantially tubular shape centered on a central axis of the pipe main body and including a male screw portion on an external surface thereof, and into which an end portion of the pipe main body is inserted, thereby being fixed to the end portion, wherein when the pipe main body is connected to another pipe main body, the male screw portion is screwed with a female screw portion that is provided on an internal surface of a coupling that has a substantially tubular shape, the male screw portion includes, near a screw thread surface, a metallic mesh layer or a glass fiber or carbon fiber layer that has a shape conforming to the shape of the screw thread surface as a reinforcement layer, and other regions of the male screw portion than the reinforcement layer are made from a resin.

According to the present invention, it is possible to suppress breakage of a male screw portion.

In a preferable embodiment of the present invention, the male screw portion is a taper screw.

In this case, it is preferable that an external surface of the end portion of the pipe main body includes a main body inclined surface whose diameter is gradually reduced toward an end face, and an internal surface of the connection portion includes an opposing inclined surface that is to be bonded to the main body inclined surface. Accordingly, it is easily possible to provide a taper screw while reducing the thickness of the connection portion.

The pipe is preferably used for pumping crude oil from an oil well.

The present invention is also directed to a method for manufacturing a pipe. The method includes the steps of: a) preparing a first inner mold whose external surface, which is a substantially cylindrical surface, has a threaded shape, and a first outer mold whose internal surface, which is a substantially cylindrical surface centered on a central axis of the first inner mold, has a shape conforming to the shape of the external surface of the first inner mold and that is separable into a plurality of members, and disposing a metallic mesh sheet or a glass fiber or carbon fiber sheet between the first inner mold and the first outer mold, thereby molding a reinforcement layer; b) separating the first outer mold to remove the reinforcement layer from the first inner mold; c) preparing a second inner mold whose external surface is a substantially cylindrical surface, and a second outer mold whose internal surface, which is a substantially cylindrical surface centered on the central axis of the second inner mold, has a shape conforming to the threaded shape and that is separable into a plurality of members, and supplying a resin between the second inner mold and the second outer mold, with the reinforcement layer disposed therebetween, thereby molding a connection portion; d) separating the second outer mold to remove the connection portion from the second inner mold; and e) inserting and fixing an end portion of a tubular-shaped pipe main body that is made from fiber reinforced plastic into the connection portion. With these measures, it is possible to suppress breakage of a male screw portion of an external surface of the connection portion.

The above-described object and other objects, features, embodiments, and advantages are apparent from the following detailed description of the present invention with reference to the accompanied drawings.

### BRIEF DESCRIPTION OF DRAWINGS

FIG. 1 illustrates pipes and a coupling.

FIG. 2 is a cross-sectional view illustrating a pipe and the coupling.

FIG. 3 is an enlarged cross-sectional view illustrating the vicinity of a tapered male screw portion.

FIG. 4 is a cross-sectional view illustrating a pipe and a coupling of a comparative example.

FIG. 5 is a diagram illustrating deformation of a tapered male screw portion of the pipe of the comparative example.

FIG. 6 is a diagram illustrating deformation of the tapered male screw portion of the pipe.

FIG. 7 is a diagram illustrating simulation results of stress distribution in the tapered male screw portion.

FIG. 8 is a diagram illustrating simulation results of stress distribution in the tapered male screw portion.

FIG. 9 is a diagram illustrating a flow of processing for manufacturing a pipe.

FIG. 10 is a diagram illustrating a first inner mold and a first outer mold.

FIG. 11 is a diagram illustrating molding of a reinforcement layer.

FIG. 12 is a diagram illustrating a second inner mold and a second outer mold.

FIG. 13 is a diagram illustrating molding of a connection portion.

### DESCRIPTION OF EMBODIMENTS

FIG. 1 illustrates pipes 1 according to an embodiment of the present invention, and FIG. 1 specifically illustrates two pipes 1 that are connected to each other by a coupling 5. The pipe 1 and the coupling 5 have tubular shapes with their centers on a central axis J 1. The pipes 1 are used for, for example, pumping crude oil from an oil well and, in this case, a number of pipes 1 are connected to each other via the couplings 5 in the vertical direction. The pipes 1 may be used for underground carbon dioxide storage, water desalination facilities, hot springs, geothermal electric power plants, and the like.

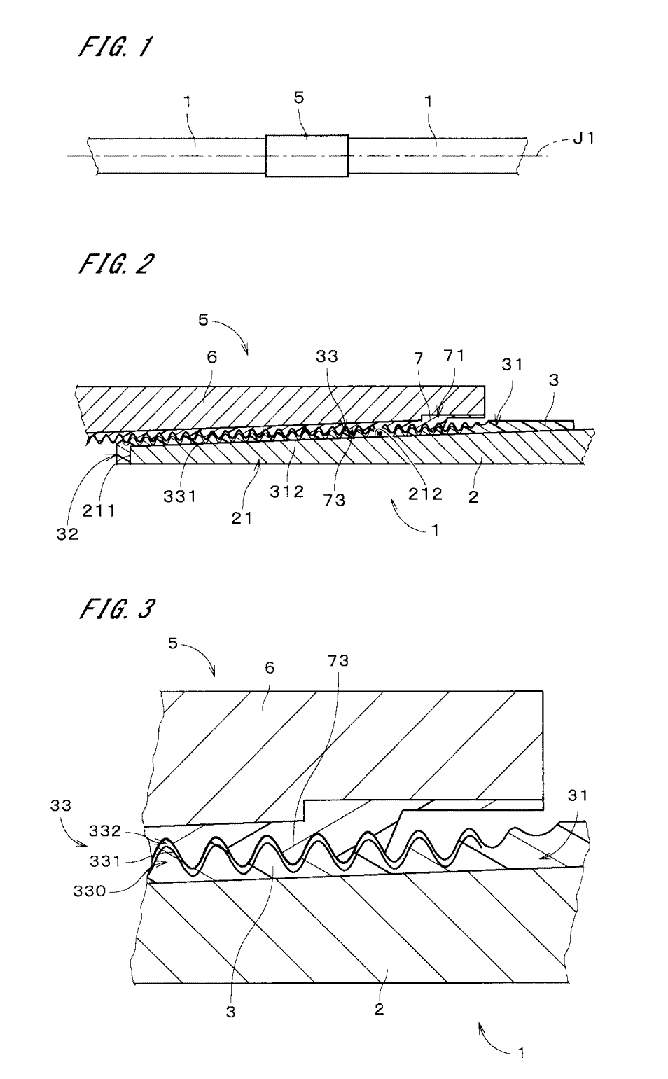

FIG. 2 is a cross-sectional view of the pipe 1 and the coupling 5, and specifically illustrates part of a cross-section that includes the central axis J1 of the pipe 1 and the coupling 5 (the portion that corresponds to the upper side of FIG. 1). The pipe 1 includes a pipe main body 2 that is made from fiber reinforced plastic, and two connection portions 3 that are provided respectively on both end portions of the pipe main body 2 (in FIG. 2, only one connection portion 3 is shown). Since the two connection portions 3 have the same shape, in the following description, attention will be given only to the connection portion 3 that is provided on one end portion 21 of the pipe main body 2. For example, the pipe main body 2 has an internal diameter of 60 millimeters (mm) and an external diameter (excluding the end portion 21) of 77 mm.

The connection portion 3 is a member that is mainly made from a resin, and has a substantially tubular shape centered on the central axis J1 (see FIG. 1). The pipe main body 2 has a tubular shape centered on the central axis J1, and the end portion 21 of the pipe main body 2 is inserted into the connection portion 3 so that the connection portion 3 is fixed to the end portion 21. Reinforced fiber or a matrix resin of the fiber reinforced plastic of the pipe main body 2 may be any of various known materials. Also, a resin from which the connection portion 3 is made may be any of various known materials.

The connection portion 3 includes: a connection portion main body 31 that has a substantially tubular shape; an annular cover portion 32 that covers an end face 211 of the pipe main body 2 at an edge of the connection portion main body 31; and a tapered male screw portion 33 that is formed on an external surface of the connection portion main body 31. An internal surface of the connection portion main body 31 has an inclined surface 312 whose diameter is gradually reduced toward the cover portion 32 (that is, toward the end face 211 of the pipe main body 2). An external surface of the end portion 21 of the pipe main body 2 also has an inclined surface 212 (hereinafter referred to as “main body inclined surface 212”) whose diameter is gradually reduced toward the end face 211, and the inclined surface 312 of the connection portion main body 31 opposes the main body inclined surface 212 of the pipe main body 2 and is bonded to the main body inclined surface 212 (for example, they are bonded together with the matrix resin of the pipe main body 2 or the resin from which the connection portion 3 is made). Hereinafter, the inclined surface 312 of the connection portion main body 31 is referred to as “opposing inclined surface 312”. The external surface of the connection portion main body 31 is also an inclined surface (circular conical surface) whose diameter is gradually reduced toward the cover portion 32, and screw threads are formed along the inclined surface, and thus the tapered male screw portion 33 is formed.

FIG. 3 is an enlarged view illustrating the vicinity of the tapered male screw portion 33. The tapered male screw portion 33 includes, near a screw thread surface, a metallic mesh layer that has a shape conforming to the shape of the screw thread surface as a reinforcement layer 331. The reinforcement layer 331 is made from, for example, stainless steel (such as SUS301) and serves as a mesh member that includes 200 meshes (that is, there are 200 sections per 1 inch). In FIG. 3, the mesh shaped reinforcement layer 331 is indicated by a solid line (the same applies to other figures). The reinforcement layer 331 is disposed between a surface layer 332, which serves as a screw thread surface, and a screw thread base portion 330 provided on an external surface of a connection portion main body 31, and adheres closely to both the surface layer 332 and the screw thread base portion 330. The screw thread base portion 330 and the surface layer 332 are made from a resin. A number of holes of the reinforcement layer 331 (holes of the metallic mesh) are also filled with a resin, and the screw thread base portion 330 and the surface layer 332 are coupled to each other (directly via the holes of the metallic mesh). This allows the screw thread base portion 330 and the surface layer 332 to be strongly bonded to the reinforcement layer 331. In the tapered male screw portion 33, the screw threads are reinforced by the reinforcement layer 331. A method for manufacturing the tapered male screw portion 33 (method for manufacturing the pipe 1) will be described later.

The main body inclined surface 212 of the pipe main body 2 in FIG. 2 is formed by grinding an external surface of an end portion of a tubular-shaped member that is intended to serve as the pipe main body 2, for example. Although reinforced fiber of the fiber reinforced plastic that constitutes the pipe main body 2 is exposed at the end face 211 and the main body inclined surface 212 of the pipe main body 2, in the pipe 1 as has already been described, the end face 211 and the main body inclined surface 212 are respectively covered with the cover portion 32 and the opposing inclined surface 312 of the connection portion 3, thus preventing degradation of the reinforced fiber due to fluid flowing through the pipe 1, exfoliation of the reinforced fiber and the matrix resin, and the like. Note that in a region on an internal surface side of the pipe main body 2, the matrix resin is present with a certain thickness so as to form a corrosion-resistant layer.

The coupling 5 in FIG. 2 includes a coupling main body 6 made from fiber reinforced plastic, and a connection portion 7 that is a member made from a resin and has a substantially tubular shape centered on the central axis J1 (see FIG. 1). The connection portion 7 is provided on an internal surface of the coupling main body 6 that has a substantially tubular shape centered on the central axis J1. The connection portion 7 includes a connection portion main body 71 that has a substantially tubular shape, and a tapered female screw portion 73 is formed on an internal surface of each end portion of the connection portion main body 71 in the direction of the central axis J1 (in the lateral direction in FIG. 2). Reinforced fiber and a matrix resin of fiber reinforced plastic of the coupling main body 6 may be any of various known materials. Also, the resin from which the connection portion 7 is made may also be any of various known materials.

When connecting one pipe 1 to another pipe 1, that is, when connecting one pipe main body 2 to another pipe main body 2, a tapered male screw portion 33 at one end portion 21 of one pipe main body 2 is screwed with one tapered female screw portion 73 that is provided on the internal surface of the coupling 5, and a tapered male screw portion 33 at one end portion 21 of the other pipe main body 2 is screwed with the other tapered female screw portion 73 of the coupling 5. Note that the tapered male screw portion 33 is tightened with respect to the tapered female screw portion 73 in a relative manner, and either one of the pipe 1 and the coupling 5 may be rotated.

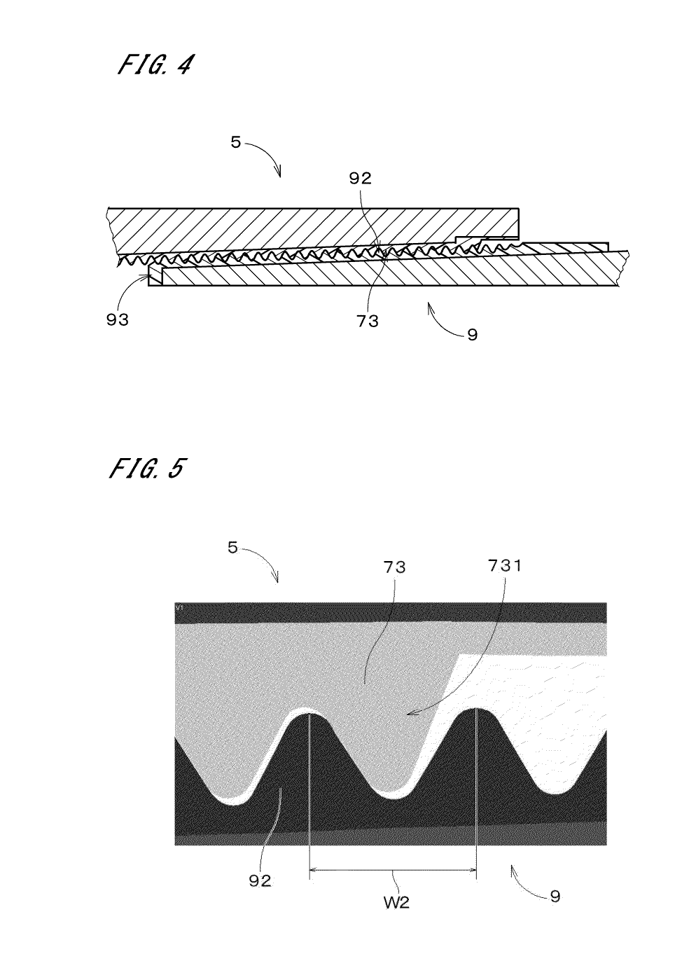

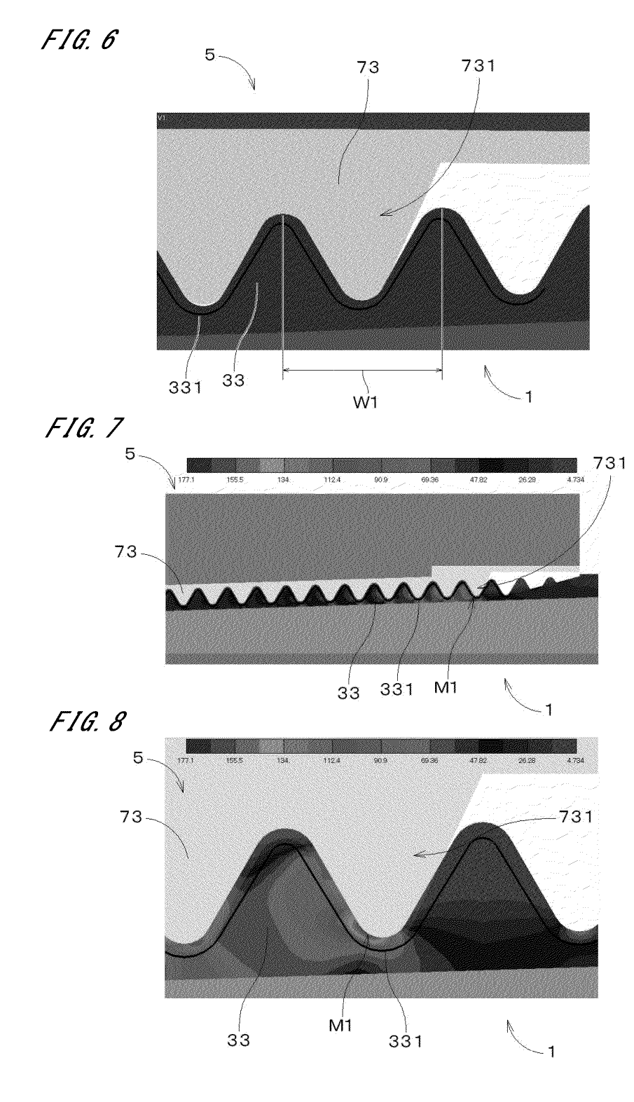

FIG. 4 is a cross-sectional view illustrating a pipe 9 of a comparative example and the coupling 5, and illustrates a cross-section that includes a central axis of the pipe 9 and the coupling 5. The pipe 9 of the comparative example is similar in configuration to the pipe 1 in FIG. 2 except that no reinforcement layer 331 is provided on a tapered male screw portion 92. When pipes are used in an oil well or the like, many pipes are connected to each other via couplings 5 in a vertical direction, so that a very large tensile load is exerted on each pipe. At this time, screw threads of the tapered male screw portion 92 of the pipe 9 of the comparative example are pressed by screw threads of the tapered female screw portion 73 of the coupling 5 toward a cover portion 93 side. Also, as illustrated in FIG. 5, the distance (the distance indicated by an arrow denoted by reference numeral W2 in FIG. 5) between two screw threads of the tapered male screw portion 92 that sandwich the screw thread at the farthest end of the tapered female screw portion 73 of the coupling 5 (that is, the screw thread on an end face side of the coupling 5 that is denoted as reference numeral 731 in FIG. 5) is greater than an original pitch between the screw threads, that is, the pitch of screw threads of the tapered male screw portion in a state in which the tapered male screw portion is not screwed with the tapered female screw portion 73. At this time, the screw threads of the tapered male screw portion 92 of the pipe 9 are fallen on the cover portion 93 side, resulting in a phenomenon that stress is concentrated on a root between the two mountains, cracks are generated and advance, and the tapered male screw portion 92 is broken.

In contrast, in the pipe 1 in FIG. 2 in which the tapered male screw portion 33 is provided with the reinforcement layer 331, even in the case where tensile load acts under the same condition as above, as shown FIG. 6, the distance (the distance indicated by an arrow denoted by reference numeral W1 in FIG. 6) between two screw threads of the tapered male screw portion 33 that sandwich the screw thread 731 at the farthest end of the tapered female screw portion 73 of the coupling 5 is smaller than the distance W2 in the pipe 9 of the comparative example. Actually, the distance W1 is substantially the same as the original pitch between the screw threads, and the degree of the screw threads of the tapered male screw portion 33 of the pipe 1 being fallen on the cover portion 32 side is reduced. As a result, exertion of a large load only on part of the root is prevented, thus suppressing a crack from being generated and advancing at roots.

Also, the pipe 1 in FIG. 6 in which the tapered male screw portion 33 is provided with the reinforcement layer 331 can have an increased strength of the area of the tapered male screw portion 33 where the reinforcement layer 331 is arranged due to the effect of the reinforcement layer 331. This allows suppression of advancement of a crack that has been generated.

FIG. 7 illustrates simulation results of stress distribution in the tapered male screw portion 33 of the pipe 1, and FIG. 8 is an enlarged diagram illustrating part of the stress distribution in the tapered male screw portion 33 of FIG. 7. FIG. 8 shows the vicinity of the screw thread 731 at the farthest end of the tapered female screw portion 73. In FIGS. 7 and 8, reference numeral M1 denotes the position where stress is at the maximum, and even when the pipe 1 is used, stress is at the maximum in the root that is in contact with the screw thread 731 at the farthest end of the tapered female screw portion 73 but is smaller than the maximum stress in the pipe 9 of the comparative example. Also, even if a crack is generated, the reinforcement layer 331 suppresses advancement of the crack.

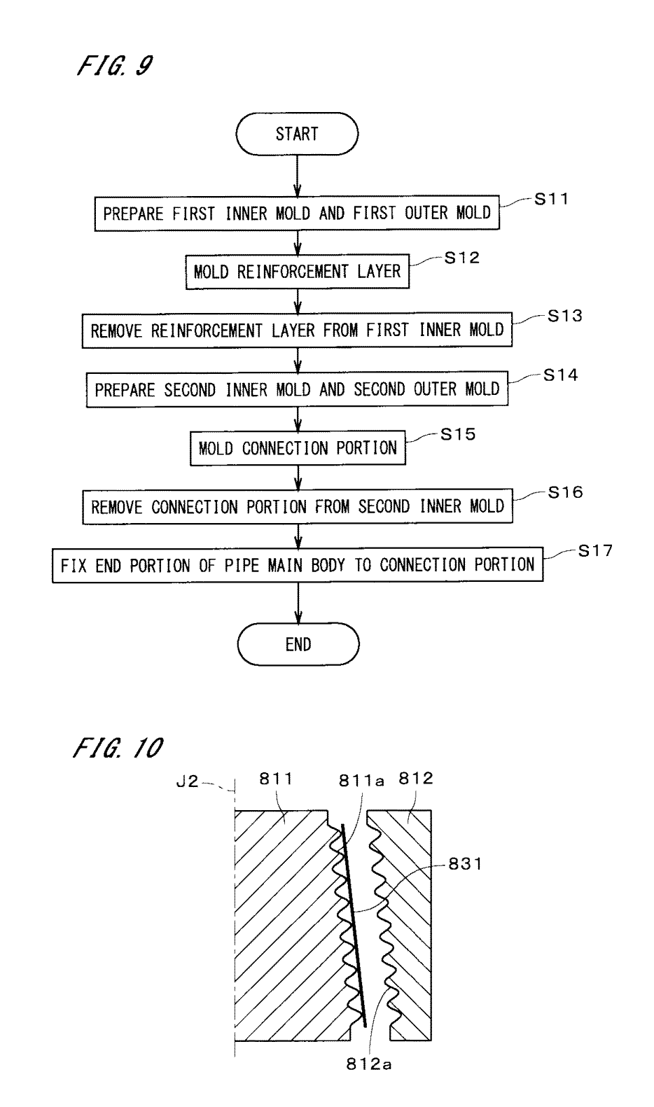

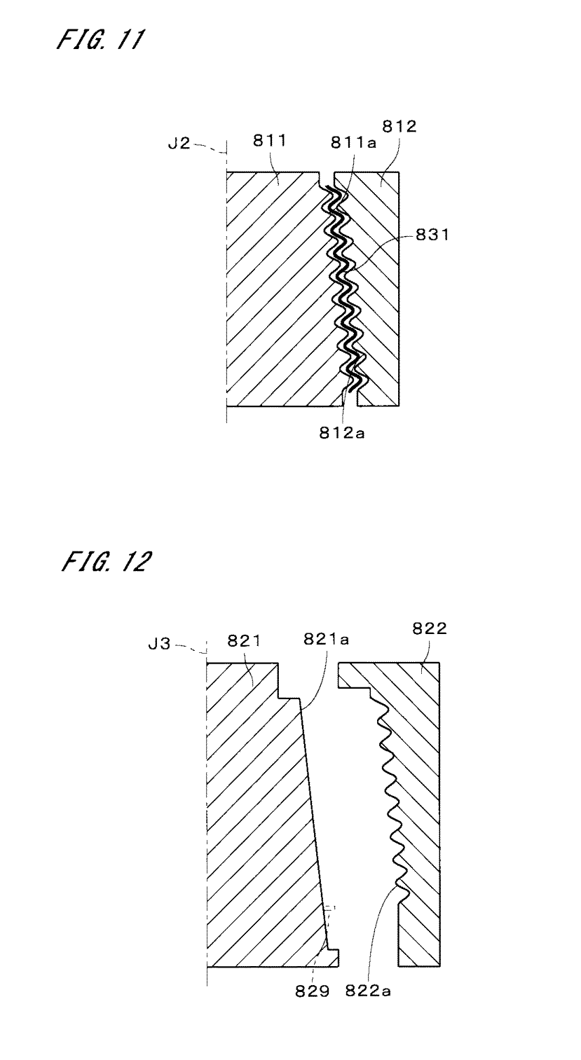

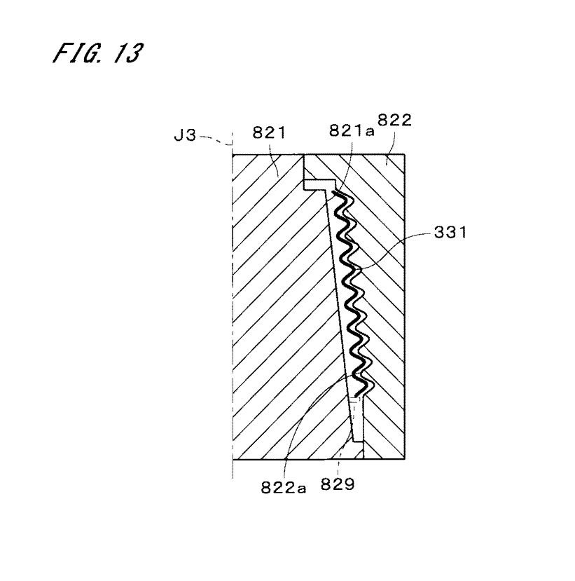

Next, processing for manufacturing the pipe 1 will be described with reference to FIG. 9. In the processing for manufacturing the pipe 1, first, as illustrated in FIG. 10, a first inner mold 811 whose external surface 811 a, which is a substantially cylindrical surface, has a threaded shape, and a first outer mold 812 whose internal surface 812a, which is a substantially cylindrical surface centered on a central axis J2 of the first inner mold 811, has the shape that conforms to the shape of the external surface 811 a of the first inner mold 811 are prepared (step S11). The first outer mold 812 is separable into a plurality of members (e.g., two members) in a circumferential direction centered on the central axis J2. FIG. 10 shows a state in which a plurality of members of the first outer mold 812 are arranged around the first inner mold 811. As described later, although the reinforcement layer 331 shown in FIG. 2 is formed using the first inner mold 811 and the first outer mold 812, FIG. 10 and FIG. 11 (described later) illustrate a simplified shape of the screw threads provided on the external surface 811 a of the first inner mold 811 and on the internal surface 812a of the first outer mold 812 (the same applies to the internal surface 822a of the second outer mold 822 in FIGS. 12 and 13 that will be described later).

Next, a metallic mesh sheet 831 is wound around the external surface 811a of the first inner mold 811 over its entire circumference. That is, the metallic mesh sheet 831 is disposed between the external surface 811a of the first inner mold 811 and the internal surfaces 812a of the first outer mold 812 that is composed of a plurality of separate members. Also, as illustrated in FIG. 11, the plurality of members of the first outer mold 812 are pressed against the external surface 811a of the first inner mold 811, and the metallic mesh sheet 831 is sandwiched between the external surface 811 a of the first inner mold 811 and the internal surfaces 812a of the first outer mold 812, so that the reinforcement layer (hereinafter, denoted as reference numeral 331) is molded (step S 12). In the present embodiment, a heat treatment (for example, a heat treatment for two hours at 400 degree C.) is performed while the metallic mesh sheet 831 is sandwiched between the first inner mold 811 and the first outer mold 812, and residual stress in the metallic mesh sheet 831 (reinforcement layer 331) is removed.

When the reinforcement layer 331 has been molded, the first outer mold 812 is removed from the first inner mold 811 while the first outer mold 812 is separated into the plurality of members, and then the reinforcement layer 331 is removed from the first inner mold 811 (step S13). At this time, it is possible to easily remove the reinforcement layer 331 by elastically deforming the reinforcement layer 331 with which the first inner mold 811 is wound. Of course, it is also possible to remove the reinforcement layer 331 from the first inner mold 811 by rotating the first inner mold 811 (or the reinforcement layer 331) around the central axis J2. Subsequently, the reinforcement layer 331 is subjected to silane coupling processing, if necessary, so that its adhesiveness to the resin that will be described later is improved.

Next, as illustrated in FIG. 12, a second inner mold 821 whose external surface 821a is a substantially cylindrical surface, and a second outer mold 822 whose internal surface 822a, which is a substantially cylindrical surface centered on a central axis J3 of the second inner mold 821, has the shape that conforms to the threaded shape are prepared (step S14). The second outer mold 822 is separable into a plurality of members (e.g., two members) in a circumferential direction centered on the central axis J3, and FIG. 12 shows a state in which the plurality of members of the second outer mold 822 are arranged around the second inner mold 821. As illustrated in FIG. 13, the plurality of members of the second outer mold 822 are connected to each other, with the reinforcement layer 331 disposed between the external surface 821a of the second inner mold 821 and the internal surface 822a of the second outer mold 822. Note that the reinforcement layer 331 is supported by the internal surface 822a of the second outer mold 822 that has the shape that conforms to the threaded shape. As shown with a chain double-dashed line in FIG. 13, the reinforcement layer 331 may be supported by a plurality of retractable members 829 that retractably protrude outward from the external surface 821a of the second inner mold 821, and are provided with equal angular space (e.g., 120 degree) around the central axis J3.

When the second inner mold 821 and the second outer mold 822 have been assembled, a liquid resin (in the present embodiment, a thermo-setting resin) is supplied into a space between the external surface 821 a of the second inner mold 821 and the internal surface 822a of the second outer mold 822. At this time, the supplied resin reaches the internal surface 822a of the second outer mold 822 through a number of holes of the reinforcement layer 331 (holes of the metallic mesh). The second inner mold 821 and the second outer mold 822 are heated externally, and the resin within the space is hardened. With this, the surface layer 332 (see FIG. 3), which serves as a screw thread surface, is formed by the resin between the internal surface 822a of the second outer mold 822 and the reinforcement layer 331, and the screw thread base portion 330 and part of the connection portion main body 31 are formed between the reinforcement layer 331 and the external surface 821 a of the second inner mold 821. With the above-described procedures, the connection portion 3 is formed (step S15). When the connection portion 3 has been formed, the second outer mold 822 is removed from the second inner mold 821 while the second outer mold 822 is separated into the plurality of members, and then the connection portion 3 is removed from the second inner mold 821 (step S16). Note that when the already described retractable members 829 are used, the retractable members 829 are retracted further inside than the external surface 821 a, and then the connection portion 3 is pulled out from the second inner mold 821. In practice, similar procedures as the above-described procedures are performed to manufacture a plurality of connection portions 3.

Meanwhile, a tubular-shaped pipe main body 2 has been formed (prepared) in advance using fiber reinforced plastic by a centrifugal molding method or the like, and both end portions 21 of the pipe main body 2 are respectively inserted into two connection portions 3 and fixed thereto (step S 17). Specifically, on both end portions 21 of the pipe main body 2, main body inclined surfaces 212 (see FIG. 2) whose diameter is gradually reduce toward the end face 211 of the corresponding end portion 21 are formed by grinding processing or the like, and the internal surface of the connection portion 3 is the opposing inclined surface 312 whose diameter is also gradually reduced toward the cover portion 32. Then, a liquid resin is applied to the main body inclined surface 212 of the pipe main body 2, the main body inclined surface 212 is inserted into the connection portion 3, and the resin is hardened (for example, thermally hardened), so that the main body inclined surface 212 and the opposing inclined surface 312 of the connection portion 3 are bonded together. With these procedures, the pipe 1 in FIG. 2 is completed.

As has been described above, in the pipe 1 in FIG. 2, the tapered male screw portion 33 includes, near the screw thread surface, a metallic mesh layer that has a shape conforming to the shape of the screw thread surface as the reinforcement layer 331. This allows breakage of the tapered male screw portion 33 that limits the tensile strength of the pipe 1 to be suppressed, thus improving the tensile strength of the pipe 1. Actually, when a tensile test was performed on two pipes connected via a coupling (see FIG. 1), the results show that tensile strength (maximum tensile load) was 171.6 kilonewton (kN) in the case where the pipes 9 of the comparative example were used as the two pipes, and was 209.7 kilonewton in the case where the pipes 1 in FIG. 2 that is provided with the reinforcement layer 331 were used as the two pipes. Although breakage of the tapered male screw portion occurred in both the pipes 9 of the comparative example and the pipes 1 in FIG. 2, the tensile strength of the pipes 1 in FIG. 2 was improved by 22%, as compared with that of the pipes 9 of the comparative example.

Although the embodiments of the present invention have been described, the present invention is not limited to the above-described embodiments, and various modifications are possible.

Although in the above-described embodiment, the reinforcement layer 331 of the metallic mesh is made from a metallic mesh sheet, the reinforcement layer 331 may be made from another material. For example, the reinforcement layer 331 (including part of the surface layer 332 and part of the screw thread base portion 330) may be formed by disposing a glass fiber or carbon fiber prepreg sheet (that is, a sheet formed by impregnating glass fiber or carbon fiber with a resin) between the first inner mold 811 in FIG. 10 and the first outer mold 812 and pressing and heating the sheet. The reinforcement layer 331, which is a glass fiber or carbon fiber layer, is removed from the first inner mold 811 by rotating the first inner mold 811 (or the reinforcement layer 331) around the central axis J2. Also, as with the case where the reinforcement layer 331 of the metallic mesh is used, a resin is supplied between the second inner mold 821 and the second outer mold 822, with the reinforcement layer 331 made from glass fiber or carbon fiber disposed therebetween, and thereby the connection portion 3 is molded.

The reinforcement layer 331 is not necessarily provided over the entire tapered male screw portion 33, and may be provided, for example, only in the vicinity of the region of the tapered male screw portion 33 where stress is at the maximum (in the above-described embodiment, a root that is in contact with the screw thread 731 at the farthest end of the tapered female screw portion 73 in FIG. 8).

The internal surface of the connection portion 3 may have a constant diameter, and in this case, the end portion 21 of the pipe main body 2 whose external diameter is constant is inserted into the connection portion 3, and the connection portion 3 is fixed to the end portion 21. On the other hand, as shown in FIG. 2, in the pipe 1, in which the main body inclined surface 212 that is provided on the end portion 21 of the pipe main body 2 and the opposing inclined surface 312 provided on the internal surface of the connection portion 3 are bonded together, it is easily possible to provide the tapered male screw portion 33 while reducing the thickness of the connection portion 3.

The male screw portion and the female screw portion that are provided on the pipe 1 and the coupling 5 are not necessarily taper screws in which screw threads are formed on a circular conical surface, and may be screws (so-called straight thread) in which screw threads are formed on a cylindrical surface. Also in this case, the male screw portion includes, near a screw thread surface, a metallic mesh layer or a glass fiber or carbon fiber layer that has a shape conforming to the shape of the screw thread surface, as a reinforcement layer, thereby enabling breakage of a male screw portion to be suppressed.

It is sufficient that almost the entire region of the tapered male screw portion 33 (a male screw portion in the case of a straight thread) that excludes the reinforcement layer 331 is made from a resin, and another material may also partially be used depending on design of the pipe 1.

Although the pipes 1 are particularly suitable for use in a circumstance at elevated pressure and temperature in which a high corrosion resistance property is required, as in the case of use for pumping crude oil from an oil well, the pipes 1 may, of course, be used in other circumstances than the above-described circumstance.

The configurations of the above-described embodiments and the various modifications may suitably be combined with each other, as long as they are mutually consistent.

Although the present invention has been described in detail, the descriptions having already been made are illustrative and not limiting. Therefore, it can be said that many modifications and modes are possible without departing from the scope of the present invention.

### REFERENCE SIGNS LIST

1 Pipe
2 Pipe main body
3 Connection portion
5 Coupling
21 End portion
33 Tapered male screw portion
73 Tapered female screw portion
211 End face
212 Main body inclined surface
312 Opposing inclined surface
331 Reinforcement layer
731 Screw thread
811 First inner mold
811 a External surface (of first inner mold)
812 First outer mold
812a Internal surface (of first outer mold)
821 Second inner mold
821a External surface (of second inner mold)
822 Second outer mold
822a Internal surface (of second outer mold)
831 Metallic mesh sheet
J1 to J3 Central axis
S11 to S17 Step

1. A pipe comprising:
a pipe main body that has a tubular shape and is made from fiber reinforced plastic; and
a connection portion that is a member having a substantially tubular shape centered on a central axis of the pipe main body and including a male screw portion on an external surface thereof, and into which an end portion of the pipe main body is inserted, thereby being fixed to the end portion,
wherein when the pipe main body is connected to another pipe main body, the male screw portion is screwed with a female screw portion that is provided on an internal surface of a coupling that has a substantially tubular shape,
the male screw portion includes, near a screw thread surface, a metallic mesh layer or a glass fiber or carbon fiber layer that has a shape conforming to a shape of the screw thread surface as a reinforcement layer, and other regions of the male screw portion than the reinforcement layer are made from a resin.

2. The pipe according to claim 1,
wherein the male screw portion is a taper screw.

3. The pipe according to claim 2,
wherein an external surface of the end portion of the pipe main body includes a main body inclined surface whose diameter is gradually reduced toward an end face, and an internal surface of the connection portion includes an opposing inclined surface that is to be bonded to the main body inclined surface.

4. The pipe according to claim 1, used for pumping crude oil from an oil well.

5. A method for manufacturing a pipe, comprising the steps of:
a) preparing a first inner mold whose external surface, which is a substantially cylindrical surface, has a threaded shape, and a first outer mold whose internal surface, which is a substantially cylindrical surface centered on a central axis of the first inner mold, has a shape conforming to the shape of the external surface of the first inner mold and that is separable into a plurality of members, and disposing a metallic mesh sheet or a glass fiber or carbon fiber sheet between the first inner mold and the first outer mold, thereby molding a reinforcement layer;
b) separating the first outer mold to remove the reinforcement layer from the first inner mold;
c) preparing a second inner mold whose external surface is a substantially cylindrical surface, and a second outer mold whose internal surface, which is a substantially cylindrical surface centered on the central axis of the second inner mold, has a shape conforming to the threaded shape and that is separable into a plurality of members, and supplying a resin between the second inner mold and the second outer mold, with the reinforcement layer disposed therebetween, thereby molding a connection portion;
d) separating the second outer mold to remove the connection portion from the second inner mold; and
e) inserting and fixing an end portion of a tubular-shaped pipe main body that is made from fiber reinforced plastic into the connection portion.

6. The method for manufacturing a pipe according to claim 5,
wherein a male screw portion of an external surface of the connection portion is a taper screw.

7. The method for manufacturing a pipe according to claim 6,
wherein an external surface of the end portion of the pipe main body includes a main body inclined surface whose diameter is gradually reduced toward an end face, and an internal surface of the connection portion includes an opposing inclined surface that is to be bonded to the main body inclined surface.

8. The pipe according to claim 2, used for pumping crude oil from an oil well.

9. The pipe according to claim 3, used for pumping crude oil from an oil well.
